(19) United States
(12) Patent Application Publication
(10) Pub. No.: US 2011/0090817 A1
(43) Pub. Date: Apr. 21, 2011

(54) SENDING METHOD, RECEIVING METHOD, SENDING DEVICE, AND RECEIVING DEVICE FOR SIGNALS IN MULTI-CARRIER SYSTEM

(75) Inventors: Binyu QU, Shenzhen (CN); Deping Liu, Shenzhen (CN)

(73) Assignee: HUAWEI TECHNOLOGIES CO., LTD., Shenzhen (CN)

(21) Appl. No.: 12/977,611

(22) Filed: Dec. 23, 2010

Related U.S. Application Data
(63) Continuation of application No. PCT/CN2009/072421, filed on Jun. 24, 2009.

(30) Foreign Application Priority Data
Jun. 24, 2008 (CN) 200810125014.0

(51) Int. Cl. H04W 4/00

(52) U.S. Cl. 370/254; 370/328

(57) ABSTRACT

A sending method, a receiving method, a sending device, and a receiving device for signals in a multi-carrier system are provided. The sending method includes the following steps. Sequences are generated according to Cell-IDs used as parameters. The Cell-IDs satisfy predefined function corresponding relations between the Cell-IDs of multiple carriers in the same cell, and the predefined function corresponding relations include: corresponding relations between results obtained from rounding down quotients resulting from dividing the Cell-IDs of the carriers by N, where N is any integer greater than or equal to 0 and smaller than or equal to a maximum value of the Cell-IDs. Signals formed by the sequences or formed due to action of the sequences are sent. The methods and devices facilitate cell planning for the multi-carrier system, and avoid the uplink pilot interference between different cells.

### CROSS-REFERENCE TO RELATED APPLICATIONS

This application is a continuation of International Application No. PCT/CN2009/072421, filed on Jun. 24, 2009, which claims priority to Chinese Patent Application No. 200810125014.0, filed on Jun. 24, 2008, both of which are hereby incorporated by reference in their entireties.

### FIELD OF THE INVENTION

The present invention relates to the field of communications and network technologies, and in particular, to a sending method, a receiving method, a sending device, and a receiving device for signals in a multi-carrier system.

### BACKGROUND OF THE INVENTION

A cell-ID is very important. In the existing Long Term Evolution (LTE) system, a sequence is generated according to the Cell-ID used as a parameter, and a signal is formed by the sequence or formed due to action of the sequence. In the system, a Cell-ID is used as one initial parameter of a random sequence sent on a downlink pilot of a cell and a scrambling sequence of a downlink channel. Resource mapping modes of the downlink pilot and other channels are affected by Cell-IDs, and a random sequence of a synchronous channel is also determined by a Cell-ID. In addition, A Cell-ID further determines a sequence-group number which an uplink pilot belongs to, and thus determines a code to be used when a user equipment (UE) sends the uplink pilot.

A future LTE-A system is capable of supporting wider bandwidth, and a possible method for supporting wider bandwidth is carrier aggregation, that is, assigning multiple carriers to a user simultaneously. Each of the carriers is also called a component carrier, which may be an LTE carrier, and at this time, a UE supporting the LTE may access the LTE carrier. Definitely, some carriers may be non-LTE carriers, and at this time, the LTE UE may not access the non-LTE carrier. In either case, by using a design of carrier aggregation, most of LTE designs that already exist in each component carrier may be reserved, and the alterations on the system side and the UE side can be reduced.

When the carrier aggregation is adopted, if Cell-IDs of several component carriers are identical, code sequences of downlink common pilots on multiple carriers of a transmitting unit and code sequences on a synchronous channel may be completely identical at the same time, which leads to a high Peak Average Power Ratio (PAPR). Moreover, for the uplink, if Cell-IDs of multiple carriers are the same, the multiple carriers belong to the same hopping sequence group, and have the same group hopping pattern as well as the same sequence-shift pattern. At this time, if on several carriers the same bandwidth is allocated to the UE, the probability that the same code sequence of the uplink pilot is transmitted on the multiple carriers-to the UE is increased, and the problem of a high PAPR may easily occur. To avoid the above problem, when the carrier aggregation is adopted, the system should allocate different Cell-IDs to the carriers in the same cell. The same cell refers to the cell at the same geographical location, while different cells refer to the cells at different geographical locations.

However, during the implementation of the present invention, the inventors find that, if a relationship between Cell-IDs of multiple carriers in the same cell is not specifically defined in the light of various signals that is affected by the Cell-IDs, the cell planning for a multi-carrier system becomes difficult, and even the uplink pilot interference between different cells may occur.

### SUMMARY OF THE INVENTION

Accordingly, the present invention is directed to a sending method, a receiving method, a sending device, and a receiving device for signals in a multi-carrier system, so as to facilitate cell planning for the multi-carrier system. Through the provided methods and devices, multiple carriers do not need to be planned respectively; instead, as long as the carriers of a certain frequency in the multiple cells are planned, the carriers of other frequencies in these cells may easily follow the preset planning, and thus the uplink pilot interference between different cells in the multi-carrier aggregation condition of the prior art can be solved.

The present invention is implemented as follows.

An embodiment of the present invention provides a method for sending a signal in a multi-carrier system, where the method includes:

generating a sequence according to a Cell-ID used as a parameter, where the Cell-ID satisfies a predefined function corresponding relation between Cell-IDs of multiple carriers in the same cell, and the predefined function corresponding relations comprises: a corresponding relation between results obtained from rounding down quotients resulting from dividing the Cell-IDs of the carriers by N; and/or a corresponding relation between remainders obtained from dividing the Cell-IDs of the carriers by N, where N is any integer greater than 0 and smaller than or equal to a maximum value of the Cell-IDs; and

sending a signal formed by the sequence or formed due to processed of the sequence.

An embodiment of the present invention provides a method for receiving a signal in a multi-carrier system, where the method includes:

detecting a cell-ID of a component carrier in a cell or adjacent cell;

obtaining multi-carrier configuration information of the cell or the adjacent cell sent by a network side entity;

obtaining a random sequence on a synchronous channel of another component carrier in the cell or the adjacent cell; wherein the random sequence is obtained by computing according to a predefined function corresponding relation between Cell-IDs of the component carriers in the cell or the adjacent cell and the multi-carrier configuration information provided by the network side entity;

receiving the random sequence; wherein the predefined function corresponding relation comprises: a corresponding relation between results obtained from rounding down quotients resulting from dividing the Cell-IDs of the carriers by N; and/or a corresponding relation between remainders obtained from dividing the Cell-IDs of the carriers by N, where N is any integer greater than 0 and smaller than or equal to a maximum value of the Cell-IDs.

An embodiment of the present invention provides a device for sending a signal in a multi-carrier system, where the device includes:

a first processing unit, configured to generate a sequence by using a Cell-ID as a parameters, wherein the Cell-ID satisfies a predefined function corresponding relation between Cell-IDs of multiple carriers in the same cell, and the predefined function corresponding relation comprises: a corresponding relation between results obtained from rounding down quotients resulting from dividing the Cell-IDs of the carriers by N; and/or a corresponding relation between remainders obtained from dividing the Cell-IDs of the carriers by N, where N is any integer greater than 0 and smaller than or equal to a maximum value of the Cell-IDs; and

a second processing unit, configured to send a signal formed by the sequence or formed due to action of the sequence.

An embodiment of the present invention provides another device for receiving a signal in a multi-carrier system, where the device includes:

a third processing unit, configured to receive a signal formed by a sequence or formed due to action of the sequence, wherein the sequence is generated according to a Cell-ID used as a parameter, the Cell-ID satisfies a predefined function corresponding relation between Cell-IDs of multiple carriers in the same cell, and the predefined function corresponding relation comprises: a corresponding relation between results obtained from rounding down quotients resulting from dividing the Cell-IDs of the carriers by N; and/or a corresponding relation between remainders obtained from dividing the Cell-IDs by N, where N is any integer greater than 0 and smaller than or equal to a maximum value of the Cell-IDs.

It can be seen from the above technical solutions that, compared with the prior art, the present invention has the following advantages and features. In the embodiments of the present invention, the corresponding relations between the Cell-IDs of the multiple carriers in the same cell are specifically defined, which facilitates the cell planning for the multi-carrier system and ensures the uplink pilot interference of different carriers of the same frequency between the cells to be low.

### BRIEF DESCRIPTION OF THE DRAWINGS

FIG. 1 is a first schematic view of Cell-IDs of carriers in different cells;

FIG. 2 is a second schematic view of Cell-IDs of carriers in different cells;

FIG. 3 is a third schematic view of Cell-IDs of carriers in different cells;

FIG. 4 is a flow chart of a method for receiving a signal in a multi-carrier system according to an embodiment of the present invention;

FIG. 5 is a flow chart of a method for receiving a signal in a multi-carrier system according to another embodiment of the present invention;

FIG. 6 is a schematic structural view of a device for sending a signal in a multi-carrier system according to an embodiment of the present invention;

FIG. 7 is a schematic structural view of a device for receiving a signal in a multi-carrier system according to an embodiment of the present invention; and

FIG. 8 is a schematic structural view of a device for receiving a signal in a multi-carrier system according to another embodiment of the present invention.

### DETAILED DESCRIPTION OF THE EMBODIMENTS

504 Cell-IDs are provided in the existing LTE system, and the values of these Cell-IDs are in a range of 0 to 503. Sequences that can be adopted by uplink pilots are divided into 30 sequence groups, and correspondingly, the technical solution for the current LTE system to compute the sequence groups used by the uplink pilots according to the Cell-IDs is as follows (other parameters irrelevant to the present invention are omitted).

When a group hopping of an uplink pilot is activated, for a certain cell, the result obtained from rounding down the quotient of dividing the Cell-ID of the cell by 30 [floor (Cell_id/30)] is in a range of 0 to 16, that is, 17 values in total. With the obtained result serving as an initial value of a shift register of a pseudo random sequence, a sequence-group hopping pattern of a sequence-group hopping is generated, which is expressed by f_gh, for example, a sequence-group sequence may be generated as a_{—}1, a_{—}2, a_{—}3, . . . , a_N, where a_{—}1, a_{—}2, . . . are taken from 0 to 29 and are corresponding to the sequence groups 0 to 29, respectively.

The remainder obtained from dividing the Cell-ID by 30 (Cell_id mod 30) is a sequence-shift pattern of the sequence-group hopping pattern of the cell, and assume that the remainder is expressed by f_ss, the value of which is in a range of 0 to 29.

The sequence group adopted by the uplink pilot in the cell is co-determined by the group hopping pattern and the sequence-shift pattern [(f_gh+f_ss)mod 30]. If the determined sequence-group sequence corresponding to the sequence-group hopping pattern is a_{—}1, a_{—}2, a_{—}3, . . . , a_N, where a_{—}1, a_{—}2, . . . are taken from 0 to 29; and the value of the sequence-shift pattern is f_ss, the adopted sequence group of the uplink pilot is a_{—}1+f_ss, a_{—}2+f_ss, . . . , a_n+f_ss, and if a_n+f_ss is larger than 30, a_n+f_ss mod 30 is the sequence group number.

When the group hopping of the uplink pilot is not activated, for a certain cell, the sequence group adopted by the uplink pilot is determined by the remainder obtained from dividing the Cell-ID of the cell by 30 (Cell_id mod 30), that is, the sequence-shift pattern of the cell. As described above, the remainder is valued from 0 to 29, and expressed by f_ss.

A UE determines code sequences of a certain length in the current sequence group to be sent according to the assigned uplink frequency resource.

Since the prior art provides a corresponding relation between a Cell-IDs and a sequence group adopted by a uplink pilot, the planning of the uplink pilot sequence group of the multiple cells can be achieved by planning the Cell-IDs carefully, thereby reducing the uplink pilot interference between multiple cells.

To facilitate the cell planning for the multi-carrier system and the planning of the uplink pilot sequence group of the multiple cells in the multi-carrier system by the Cell-IDs planning so as to reduce the uplink reference signal interference between multiple cells, in an embodiment, the present invention provides a receiving method and a sending method for signals in a multi-carrier system. In the receiving method and the sending method of the present invention, a sequence is generated by using a Cell-ID as a parameter, and when a signal formed by the sequence or formed due to action of the sequence is sent or received, it is required that the Cell-IDs of different carriers in the same cell have specifically a predefined function corresponding relation, so as to facilitate the planning for the uplink pilot sequence group of different cells in the multi-carrier system and avoid the problem of uplink pilot interference between different cells in the multi-carrier system.

For the foregoing relation between a Cell-ID and a sequence group adopted by an uplink pilot, the predefined function corresponding relation is as follows.

Assume that the Cell-ID of a reference carrier is Cell_id_{—}1, the corresponding relation between a Cell-ID of the n^{th} carrier Cell_id_n and the Cell-ID of the reference carrier Cell_id_{—}1 may be expressed by the following two formulas or either of the two formulas:

floor(Cell_{—}id_{—}n/N)=f{floor(Cell_{—}id_{—}1/N),n} (1)

Cell_{—}id_{—}n mod N=g{(Cell_{—}id_{—}1 mod N),n} (2)

In the two formulas, floor(x) represents rounding down the argument x, for example, floor(16.5)=16; “/” represents the operation of division; Y mod X represents a remainder obtained from dividing Y by X, for example, 5 mod 3=2; and N is any integer larger than 0 and smaller than or equal to a maximum value of Cell-IDs.

f and g are two functions that specify the corresponding relation between Cell-IDs of carriers in a multi-carrier system. f defines the function relation between values obtained by respectively performing the operation of “floor(Cell_id/N)” to two Cell-IDs, where the two arguments are respectively “floor(Cell_id/N) and the name of a carrier, and the values are integers in a range of [0, 16]; g defines the function relation between values obtained by respectively performing the operation of “Cell_id mod N” to the two Cell-IDs, where the two arguments are respectively the “Cell_id mod N” and the name of the carrier, and the values are integers in a range of [0, 29]. Further, the two arguments may respectively be “floor(Cell_id/N)” and the name of the carrier, and the values are integers in a range of [0, ceil(available maximum Cell_id/N)−1]. ceil(x) represents rounding up x, for example, ceil(16.5)=17; g defines the function relation between the values obtained by respectively performing the operation of “Cell_id mod N” to the two Cell-IDs, where the two arguments are respectively the “Cell_id mod N” and the name of the carrier, and the values are integers in a range of [0, (N−1)].

Therefore, the corresponding relation between any two Cell-IDs of the carriers having the above predefined function corresponding relation in the same cell of the multi-carrier system is as follows:

$$\begin{matrix}Cell\_id \_n = floor {( Cell\_id \_n / N )}^{*} N + ( Cell\_id \_n mod N ) \\ = f {\{ floor ( Cell\_id \_ 1 / N ) , n \}}^{*} \\ N + g \{ ( Cell\_id \_ 1 mod N ) , n \}\end{matrix} \qquad ( 3 )$$

When n is fixed, f and g may be single mapping, or f and g may be random mapping, for example, f(a, n)=(a+n)mod 17, or g(a, n)=(a+n)mod N; g may be single full-mapping, for example, g may be selected as g(a, n)=(a+n)mod N, or g(a, n)=((a+1)*n mod 31)−1; and f may be further expanded as f(a, n)=(a+n)mod N.

In another embodiment of the present invention, when a sequence is generated by using a Cell-ID as a parameter, and a signal formed by the sequence or formed due to action of the sequence is sent, it is required that the Cell-IDs of different carriers in carrier sets or subsets with similar propagation characteristics and similar corresponding coverage in the same cell have the specific predefined function corresponding relation, and the Cell-IDs of the carriers with different propagation characteristics and different corresponding coverage in the same cell may not have the specific predefined function corresponding relation.

An example is given below to illustrate how to plan a sequence group of an uplink pilot between the cells for the multi-carrier system through properly planning Cell-IDs of carriers in the multi-carrier system.

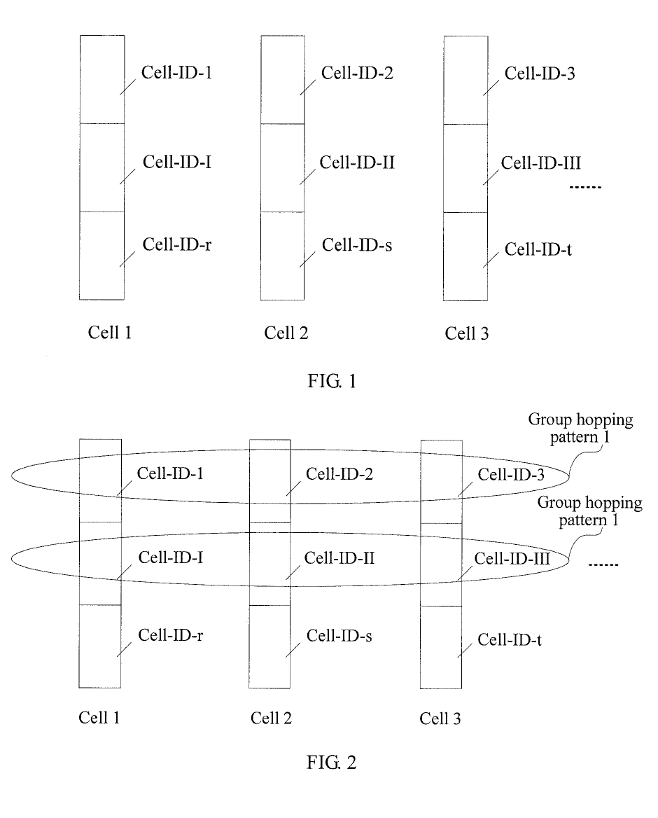

As shown in FIG. 1, N adjacent different cells form a coverage area. For example, when N=30, Cell-ID-1, Cell-ID-2, Cell-ID-3, . . . , Cell-ID-30 are Cell-IDs of carriers of the same frequency in different cells, and the values of these Cell-IDs are different; Cell-ID-I, Cell-ID-II, Cell-ID-III, . . . , Cell-ID-XXX are the Cell-IDs of carriers of another frequency in these cells, and the values of these Cell-IDs of carriers of another frequency are different; however, elements of the same value may exist in the two groups of the Cell-IDs, for example, Cell-ID-30 may be equal to Cell-ID-I. Since the Cell-IDs of different carriers in the same cell have specifically predefined function corresponding relation, planning of the uplink pilot sequence groups may be implemented through properly planning f and g, and the problem of uplink pilot interference between different cells in the multi-carrier system can be avoided accordingly.

The Cell-IDs are assigned to two carriers of the same frequency in different cells according to the following example, and after selecting the functions f and g, as long as the carriers of a certain frequency in the multiple cells are planned, the carriers of other frequencies in these cells may easily follow the preset planning.

Taking one cell as an example, the Cell-IDs of two carriers in the cell are Cell_id_{—}3 and Cell_id_III, and if the Cell-IDs of the two carriers in the cell satisfy both Formula (1) and Formula (2):

floor(Cell_{—}id_{—}III/30)=f{floor(Cell_{—}id_{—}3/30),III} (5)

Cell_{—}id_{—}III mod 30=g{(Cell_{—}id_{—}3 mod 30),III} (6)

In different cells, the values obtained from rounding down the quotients resulting from dividing the Cell-IDs of the carriers of the same frequency by 30 are the same, which are as follows:

floor(Cell_{—}id_{—}1/30)= . . . =floor(Cell_{—}id_{—}n/30) (7)

floor(Cell_{—}id_{—}A/30)= . . . =floor(Cell_{—}id_{—}N/30) (8)

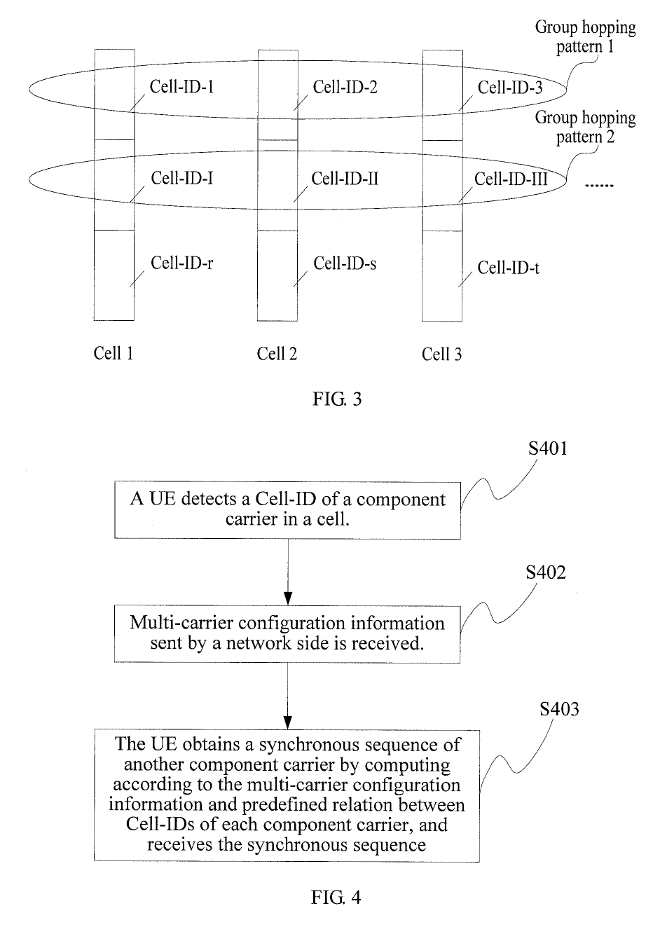

Formula (7) and Formula (8) may be identical, and in this case, the group hopping patterns of the uplink pilot sequence groups of the carriers of the two frequencies in the 30 cells are the same, as shown in FIG. 2. Formula (7) and Formula (8) may be different, and in this case, the group hopping patterns of the uplink pilot sequence groups of the carriers of the two frequencies in the 30 cells are different, as shown in FIG. 3.

Remainders obtained from dividing the Cell-IDs of the carriers of the two frequencies in different cells by 30 are {Cell_id_{—}1 mod 30, . . . , Cell_id_{—}30 mod 30} and {Cell_id_XXX mod 30, . . . , Cell_id_XXX mod 30}, that is, sequence-shift patterns of the uplink pilot sequence groups, the values of which are respectively taken from [0, 29] without repetition.

As described above, if the Cell-IDs of the two carriers in the same cell satisfy Formula (2):

Cell_{—}id_{—}III mod 30=g{(Cell_{—}id_{—}3 mod 30),III} (9)

Remainders obtained from dividing the Cell-IDs of the carriers of the two frequencies in different cells by 30 are {Cell_id_{—}1 mod 30, . . . , Cell_id_{—}30 mod 30} and {Cell_id_I mod 30, . . . , Cell_id_XXX mod 30}, that is, sequence-shift patterns of the uplink pilot sequence groups, the values of which are respectively taken from [0, 29] without repetition.

Since the Cell-IDs of different carriers in the same cell have the specifically predefined function corresponding relation, multiple carriers in the adjacent cells may have certain geographical associations through properly planning f and g, for example, the sequence-group hopping patterns adopted by the uplink pilots of the carriers of the two frequencies are identical, and only the sequence-shift patterns are different; or the sequence-shift patterns of the sequence groups adopted by the uplink pilots of the carriers of the two frequencies have certain predefined function corresponding relation. After that, as long as cell planning is performed on the carriers of a certain frequency in multiple cells against the uplink pilot interference between the different cells, the carriers of other frequencies in these cells may easily follow the preset planning, thus solving the interference of the uplink pilot sequences that may be brought up by the carrier aggregation in the prior art and simplifying the cell planning.

An embodiment of the present invention provides a method for receiving a signal in a multi-carrier system based on the above method for sending a signal in the multi-carrier system.

FIG. 4 is a flow chart of a method for receiving a signal in a multi-carrier system according to an embodiment of the present invention.

A random sequence carried by a synchronous channel is determined by a Cell-ID. When a UE receives information on multiple carriers, the UE obtains a Cell-ID the Cell-IDs of the carriers by increasing detection of a LTE terminal, and further computes a random sequence carried by a synchronous channel on each carrier. In this manner, the Cell-IDs of multiple carriers need to be detected respectively, and the procedure is complicated.

In this embodiment, it is required that the Cell-IDs of multiple carriers in carrier sets or subsets having similar propagation characteristics and similar corresponding coverage in the same cell have the above predefined function corresponding relation; and a network side entity notifies the UE of multi-carrier configuration information of a local cell, which includes: the number of the carriers of the aforementioned one or more carrier sets or the subsets in the local cell, and frequency-domain positions of the carriers. After detecting a synchronous channel on one component carrier, the UE computes random sequences of the synchronous channels on the other component carriers in the corresponding carrier sets or the subsets according to the pre-acquired multi-carrier configuration information of the cell and the pre-defined function corresponding relation between the Cell-IDs of the carriers, and receives a signal.

Specifically, the method includes the following steps.

Step S401: A UE detects a Cell-ID of a component carrier in a cell.

Step S402: Multi-carrier configuration information of the cell sent by a network side entity is received.

The multi-carrier configuration information includes: the number of carriers of one or more carrier sets or subsets in the cell, and frequency-domain positions of the carriers.

Step S403: the UE obtains a synchronous sequence of another component carrier in the corresponding carrier sets or the subsets by computation according to the multi-carrier configuration information and the predefined function corresponding relation between the Cell-IDs of each component carrier, and receives the synchronous sequence.

It should be noted that, the network side entity may send the multi-carrier configuration information via broadcast or Radio Resource Control (RRC) dedicated signaling.

In the embodiment of the present invention, through the predefined function corresponding relation between the Cell-IDs of the carriers and the multi-carrier configuration information of a cell, that is notified to the UE, including the number of the carriers of the above one or more carrier sets or the subsets in the cell and the frequency-domain positions of the carriers, the Cell-IDs of each component carrier in the carrier sets or the subsets are computed, and the random sequences of the synchronous channels on the carriers are determined and received, which is easy and convenient.

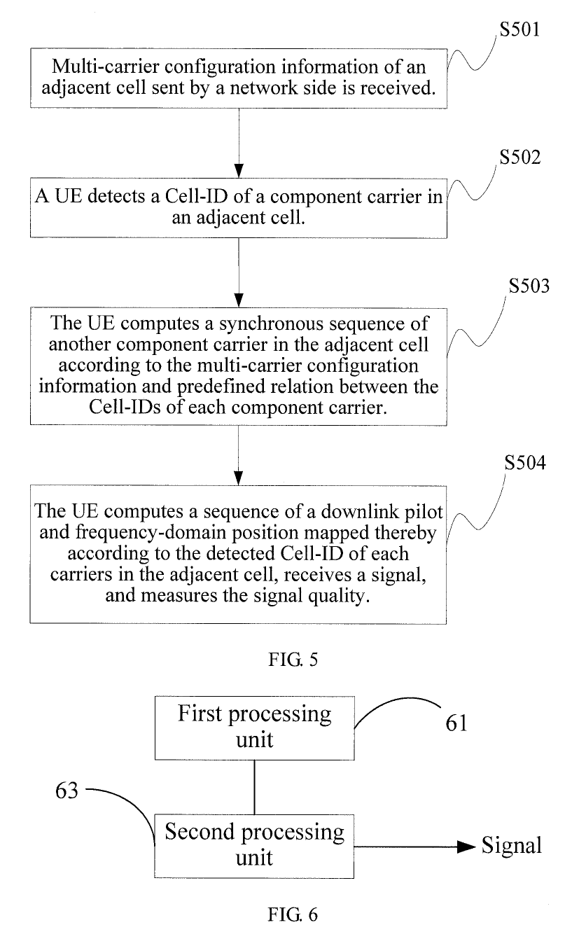

FIG. 5 is a flow chart of a method for receiving a signal in a multi-carrier system according to another embodiment of the present invention.

When performing cell handover, the UE needs to ensure the continuity of services and a steady data rate. Therefore, before and after the handover, the network side entity needs to assign stable frequency resources to the UE; as a result, preferably, the UE needs to support carrier aggregation during the handover.

The UE in a handover state should know the specific Cell-IDs, the corresponding carriers of which can be aggregated in the adjacent cell, so that the carrier aggregation can still be applied after the handover. In the prior art, the UE fails to determine whether the corresponding carriers belong to one adjacent cell, and whether the carriers can be aggregated in the adjacent cell according to the detected Cell-IDs. Another defect of the prior art is that the signal intensity of the adjacent cell needs to be measured for the handover, so that in the prior art, the Cell-IDs of multiple carriers need to be detected respectively, and the procedure is complicated.

In this embodiment, it is required that the Cell-IDs of the carriers in the same cell have the above predefined function corresponding relation; and in the case of multi-carrier aggregation, the network side entity notifies the UE of multi-carrier configuration information of the adjacent cell, which includes the number of the carriers in the above one or more carrier sets or the subsets in the cell, and the frequency-domain positions of the carriers. After detecting a synchronous channel on a component carrier of the carrier set or the subset in the adjacent cell, the UE computes the sequences of the synchronous channels of the other component carriers in the carrier sets or the subsets in the adjacent cell according to the pre-acquired multi-carrier configuration information and the predefined function corresponding relation between the Cell-IDs of the carriers, and receives a signal, so as to implement the detection on the multiple carriers in the adjacent cell and the measurement of the signal quality, and to further perform handover according to the result of the measurement.

Specifically, the method includes the following steps.

Step S501: Multi-carrier configuration information of an adjacent cell sent by a network side entity is received.

The multi-carrier configuration information includes the number of the carriers in above one or more carrier sets or subsets in the adjacent cell, and the frequency-domain positions of the carriers. The multi-carrier configuration information usually is the multi-carrier configuration information of multiple adjacent cells.

Step S502: A UE detects a Cell-ID of a component carrier in an adjacent cell.

Step S503: The UE obtains a synchronous sequence of another component carrier in the corresponding carrier sets or the subsets in the adjacent cell by computation according to the multi-carrier configuration information and the predefined function corresponding relation between the Cell-IDs of each component carrier, and receives the synchronous sequence.

Step S504: The UE computes a sequence of a downlink pilot and frequency-domain position mapped thereby according to the detected Cell-ID of each carrier in the adjacent cell, receives a signal, and measures the signal quality.

Through the above steps S501 to 5504, the detection and measurement on multiple carriers in an adjacent cell are accomplished. Usually, multiple adjacent cells need to be detected and measured, and thus Steps S501, S502, S503, and S504 are repeated.

It should be noted that the network side entity may send the multi-carrier configuration information via broadcast or RRC dedicated signaling.

In the embodiment of the present invention, the UE is enabled to determine the specific Cell-IDs, the corresponding carriers of which belong to the same adjacent cell, according to the predefined function corresponding relation between the Cell-IDs of the carriers in the above one or more carrier sets or the subsets in the same cell, and to further determine the specific carriers that can be aggregated. Therefore, the carrier aggregation can still be applied after the handover, thus simplifying the detection of the multiple carriers in the adjacent cell and the measurement of the signal quality.

In the above embodiment, after detecting a Cell-ID of a component carrier of a certain cell, the UE obtains the synchronous sequences of the other component carriers in the corresponding carrier sets or the subsets in the cell by computation according to the multi-carrier configuration information and the predefined function corresponding relation between the Cell-IDs of the carriers in the cell, and receives the synchronous sequences. The predefined function corresponding relation between the Cell-IDs of the carriers in the cell may be pre-stored in the UE, or provided by the network side entity.

In another embodiment of the present invention, the network side entity provides a Cell-ID having the above predefined function corresponding relation to the UE via broadcast or RRC dedicated signaling. In other embodiments of the present invention, after detecting a Cell-ID of a component carrier of a certain cell, the UE may send request information including the Cell-ID to the network side entity; and after receiving the request information, the network side entity provides a Cell-ID that has the above predefined function corresponding relation with the Cell-ID to the UE.

In accordance with the above embodiments of the methods, an embodiment of the present invention further provides a device for sending a signal in a multi-carrier system.

A device for sending a signal in a multi-carrier system according to an embodiment of the present invention is shown in FIG. 6, which includes a first processing unit 61 and a second processing unit 62.

The first processing unit 61 is configured to generate a sequence by using a Cell-ID as parameters, where the Cell-ID satisfy predefined function corresponding relation between Cell-IDs of multiple carriers in the same cell. Specifically, the sequence is generated according to the Cell-ID of the carrier used as a parameter; the Cell-IDs of any two carriers in carrier sets or subsets having similar propagation characteristics and similar coverage in the same cell have the predefined function corresponding relation; the predefined function corresponding relation has been described above, and the details will not be described herein again.

The second processing unit 62 is configured to send a signal formed by the sequence or formed due to action of the sequence.

The signal is the transmitting sequence of an uplink pilot, and the transmitting sequence carried by the uplink pilot is determined by a group hopping pattern and a sequence-shift pattern. In other embodiments, the signal is a random signal of a synchronous channel, and definitely may be other signals, specific examples of which will not be given herein.

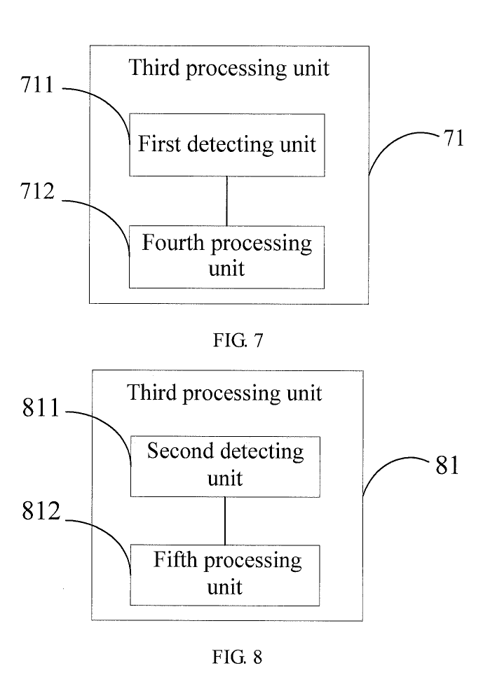

A device for receiving a signal in a multi-carrier system according to an embodiment of the present invention is shown in FIG. 7, which includes a third processing unit 71 for receiving a signal.

The signal are formed by a sequence or formed due to action of the sequence. A Cell-ID of a carrier satisfies predefined function corresponding relation as described in the foregoing method part.

The signal may be a random signal of a synchronous channel, and in this case, the third processing unit 71 may include a first detecting unit 711 and a fourth processing unit 712.

The first detecting unit 711 is configured to detect a Cell-ID on a component carrier of a cell.

The fourth processing unit 712 is configured to obtain a random sequence of the other component carrier on the a synchronous channel in the cell by computation according to pre-acquired multi-carrier configuration information and the predefined function corresponding relation between Cell-IDs of each component carrier in the cell, and receive the random sequence. The multi-carrier configuration information includes: the number of the carriers of one or more carrier sets or subsets in the cell, and the frequency-domain positions of the carriers.

The multi-carrier configuration information is sent by the network side entity, and the network side entity may send the multi-carrier information via broadcast or RRC dedicated signaling.

In the above embodiment, the predefined function corresponding relation between a Cell-ID of each component carrier in the cell may be pre-stored in the UE, or provided by the network side entity, and according to the predefined function corresponding relation, the UE computes and receives a random sequence of the synchronous channel on the other component carriers in the cell. In another embodiment of the present invention, the network side entity provides a Cell-ID having the above predefined function corresponding relation to the UE via broadcast or RRC dedicated signaling. While in the following embodiment, after detecting the Cell-ID of a component carrier in the cell, the UE sends a request to the network side entity, the network side entity provides a Cell-ID of the other carrier having the above predefined function corresponding relation with the Cell-ID to the UE according to the request, and the UE receives a random sequence of a synchronous channel according to the Cell-ID of the other carrier.

The above embodiment is mainly for describing the processing a signal of a carrier in the cell by the UE. In the embodiment described below, the UE performs processing on a signal of a carrier in an adjacent cell of the local cell according to predefined function corresponding relation between Cell-IDs of the carriers in the same cell. Another device for receiving a signal in a multi-carrier system according to another embodiment of the present invention is shown in FIG. 8, which includes a third processing unit 81 for receiving a signal. The signal is formed by a sequence or formed due to action of the sequence. The Cell-IDs of the carriers satisfy the predefined function corresponding relation described in the foregoing method part.

The signal may be a random signal of a synchronous channel, and in this case, the third processing unit 81 may include a second detecting unit 811 and a fifth processing unit 812.

The second detecting unit 811 is configured to receive multi-carrier configuration information sent by a network side entity, and detect a Cell-ID of a component carrier in an adjacent cell of the local cell, where the multi-carrier configuration information includes: the number of the carriers in carrier sets or subsets in the adjacent cell and the frequency-domain positions of the carriers, and the carriers in the carrier sets or the subsets have a similar propagation characteristic and coverage.

The fifth processing unit 812 is configured to obtain a random sequence of a synchronous channel on the other component carrier in the adjacent cell by computing according to predefined function corresponding relation between Cell-IDs of each component carrier of the adjacent cell, and receive the random sequence.

The multi-carrier configuration information is sent by the network side entity, and the network side may send the multi-carrier information via broadcast or RRC dedicated signaling.

In other embodiments, after detecting the Cell-ID of a component carrier in the local cell, the UE sends a request to the network side entity, the network side entity provides the Cell-ID of the other carrier having the above predefined function corresponding relation with the Cell-ID to the UE according to the request, and the UE receives a the random sequence of a synchronous channel on the carriers in the adjacent cell according to a Cell-ID of each carrier. In this case, another device for receiving a signal in a multi-carrier system according to the embodiment of the present invention includes a fourth processing unit.

The fourth processing unit is configured to receive information including a Cell-ID provided by a network side entity, where the Cell-ID satisfies predefined function corresponding relation between Cell-IDs of multiple carriers in the same cell, and the predefined function corresponding relation includes: corresponding relation between results obtained from rounding down quotients resulting from dividing a Cell-ID of a carrier by N; and/or corresponding relation between remainders obtained from dividing the Cell-ID of the carrier by N, where N is any integer larger than 0 and smaller than or equal to a maximum value of the Cell-IDs.

The specific corresponding relation between the results obtained from rounding down the quotients of dividing the Cell-IDs of the carriers by N includes that: the results obtained from rounding down the quotients of dividing the Cell-IDs of the carriers by N are equal, where N is any integer larger than 0 and smaller than or equal to the maximum value of the Cell-IDs.

Persons of ordinary skill in the art may understand that information, messages, and signals may be represented by using any one of many different techniques and technologies. For example, the messages and the information in the aforementioned description may be represented as voltages, currents, electromagnetic waves, magnetic fields or magnetic particles, optical fields, or a combination thereof.

Persons skilled in the art may further realize that, in combination with the embodiments herein, units and algorithm steps of each example described can be implemented with electronic hardware, computer software, or the combination thereof. In order to clearly describe the interchangeability between the hardware and the software, compositions and steps of each example have been generally described according to functions in the foregoing descriptions. Whether the functions are executed in a mode of hardware or software depends on particular applications and design constraint conditions of the technical solutions. Persons skilled in the art can use different methods to implement the described functions for each particular application, but it should not be considered that the implementation goes beyond the scope of the embodiments of the present invention.

In combination with the embodiments herein, steps of the method or algorithm described may be directly implemented using hardware, a software module executed by a processor, or the combination thereof. The software module may be placed in a random access memory (RAM), a memory, a read-only memory (ROM), an electrically programmable ROM (EPROM), an electrically erasable programmable ROM (EEPROM), a register, a hard disk, a removable magnetic disk, a CD-ROM, or any storage medium of other forms well-known in the technical field.

The descriptions about the embodiments enable persons skilled in the art to implement or use the embodiments of the present invention. Various modifications to the embodiments are obvious to persons skilled in the art, and general principles defined herein may be implemented in other embodiments without departing from the spirit or scope of the embodiments of the present invention. Therefore, the embodiments of the present invention may not be limited to the descriptions herein but shall fall within the broadest scope in line with the principle and novel features herein.

What is claimed is:

1. A method for sending a signal in a multi-carrier system, comprising:
generating a sequence according to a Cell-ID used as a parameter,
wherein the Cell-ID satisfies a predefined function corresponding relation between Cell-IDs of multiple carriers in the same cell, and
the predefined function corresponding relations comprises: a corresponding relation between results obtained from rounding down quotients resulting from dividing the Cell-IDs of the carriers by N; and/or a corresponding relation between remainders obtained from dividing the Cell-IDs of the carriers by N,
wherein N is any integer greater than 0 and smaller than or equal to a maximum value of the Cell-IDs; and
sending a signal formed by the sequence or formed due to processed of the sequence.

2. The method according to claim 1, wherein the corresponding relation between the results obtained from rounding down the quotients resulting from dividing the Cell-IDs of the carriers by N comprises that the results obtained from rounding down the quotients resulting from dividing the Cell-IDs of the carriers by N are equal

3. The method according to claim 1, wherein the corresponding relation between the remainders obtained from dividing the Cell-IDs of the carriers by N comprises that:
the remainders obtained from dividing the Cell-IDs of the carriers by N are equal.

4. The method according to claim 1, wherein the signal comprises a code sequence of a uplink pilot or a random signal of a synchronous channel.

5. A method for receiving a signal in a multi-carrier system, comprising:
detecting a cell-ID of a component carrier in a cell or adjacent cell;
obtaining multi-carrier configuration information of the cell or the adjacent cell sent by a network side entity;
obtaining a random sequence on a synchronous channel of another component carrier in the cell or the adjacent cell;
wherein the random sequence is obtained by computing according to a predefined function corresponding relation between Cell-IDs of the component carriers in the cell or the adjacent cell and the multi-carrier configuration information provided by the network side entity;
receiving the random sequence;
wherein the predefined function corresponding relation comprises: a corresponding relation between results obtained from rounding down quotients resulting from dividing the Cell-IDs of the carriers by N; and/or a corresponding relation between remainders obtained from dividing the Cell-IDs of the carriers by N, where N is any integer greater than 0 and smaller than or equal to a maximum value of the Cell-IDs.

6. The method according to claim 5, wherein the corresponding relation between the results obtained from rounding down the quotients resulting from dividing the Cell-IDs of the carriers by N comprises that the results obtained from rounding down the quotients resulting from dividing the Cell-IDs of the carriers by N are equal

7. The method according to claim 5, wherein the corresponding relation between the remainders obtained from dividing the Cell-IDs of the carriers by N comprises that
the remainders obtained from dividing the Cell-IDs of the carriers by N are equal.

8. The method according to claim 5, wherein the multi-carrier configuration information comprises: the number of carriers in one or more carrier sets or subsets in the cell or the adjacent and frequency-domain positions of the carriers.

9. The method according to claim 5, wherein the multi-carrier configuration information is provided by the network side entity through broadcast or dedicated signaling.

10. A device for sending a signal in a multi-carrier system, comprising:
a first processing unit, configured to generate a sequence by using a Cell-ID as a parameters, wherein the Cell-ID satisfies a predefined function corresponding relation between Cell-IDs of multiple carriers in the same cell, and the predefined function corresponding relation comprises: a corresponding relation between results obtained from rounding down quotients resulting from dividing the Cell-IDs of the carriers by N; and/or a corresponding relation between remainders obtained from dividing the Cell-IDs of the carriers by N, where N is any integer greater than 0 and smaller than or equal to a maximum value of the Cell-IDs; and
a second processing unit, configured to send a signal formed by the sequence or formed due to action of the sequence.

11. The device according to claim 10, wherein the corresponding relation between the results obtained from rounding down the quotients resulting from dividing the Cell-IDs of the carriers by N comprises that:
the results obtained from rounding down the quotients resulting from dividing the Cell-IDs of the carriers by N are equal.

12. The device according to claim 10, wherein the corresponding relation between the remainders obtained from dividing the Cell-IDs of the carriers by N comprises that:
the remainders obtained from dividing the Cell-IDs of the carriers by N are equal.

13. The device according to claim 10, wherein the signal comprises a code sequence of an uplink pilot or a random signal of a synchronous channel.

14. A device for receiving a signal in a multi-carrier system, comprising:
a third processing unit, configured to receive a signal formed by a sequence or formed due to action of the sequence,
wherein the sequence is generated according to a Cell-ID used as a parameter, the Cell-ID satisfies a predefined function corresponding relation between Cell-IDs of multiple carriers in the same cell, and the predefined function corresponding relation comprises: a corresponding relation between results obtained from rounding down quotients resulting from dividing the Cell-IDs of the carriers by N; and/or a corresponding relation between remainders obtained from dividing the Cell-IDs by N, where N is any integer greater than 0 and smaller than or equal to a maximum value of the Cell-IDs.

15. The device according to claim 14, wherein the corresponding relation between the results obtained from rounding down the quotients resulting from dividing the Cell-IDs of the carriers by N comprises that:
the results obtained from rounding down the quotients resulting from dividing the Cell-IDs of the carriers by N are equal, where N is any integer that is greater than or equal to 0 and smaller than or equal to the maximum value of the Cell-IDs.

16. The device according to claim 14, wherein the corresponding relation between the remainders obtained from dividing the Cell-IDs of the carriers by N comprises that:
the remainders obtained from dividing the Cell-IDs of the carriers by N are equal, where N is any integer greater than 0 and smaller than or equal to the maximum value of the Cell-IDs.

17. The device according to claim 14, wherein the third processing unit comprises:
a first detecting unit, configured to detect a Cell-ID on a component carrier of the local cell; and
a fourth processing unit, configured to obtain a random sequence on the synchronous channels of another component carrier in the cell by computing according to the predefined function corresponding relation between a Cell-ID of each component carrier in the cell and multi-carrier configuration information provided by the network side entity, and receive the random sequence,
wherein the multi-carrier configuration information comprises: the number of the carriers in one or more carrier sets or subsets in the cell and frequency-domain positions of the carriers, and the carriers in the carrier sets or the subsets have similar propagation characteristics and coverage.

18. The device according to claim 14, wherein the third processing unit comprises:
a second detecting unit, configured to receive the multi-carrier configuration information sent by the network side entity, and detect a Cell-ID on a component carrier of an adjacent cell of the local cell, wherein the multi-carrier configuration information comprises: the number of the carriers in carrier sets or subsets in the adjacent cell and frequency-domain positions of the carriers, and the carriers in the carrier sets or the subsets have similar propagation characteristics and coverage; and
a fifth processing unit, configured to obtain a random sequence of the another component carriers on the synchronous channels in the adjacent cell by computing according to the predefined function corresponding relation between a Cell-ID of each component carrier of the adjacent cell, and receive the random sequence.

19. The device according to claim 17, wherein the multi-carrier configuration information is provided by the network side entity through broadcast or dedicated signaling.

20. The device according to claim 18, wherein the multi-carrier configuration information is provided by the network side entity through broadcast or dedicated signaling.
